(19) United States
(12) Patent Application Publication
(10) Pub. No.: US 2008/0223470 A1
(43) Pub. Date: Sep. 18, 2008

(54) Communication Means Connecting a Portable Power Tool With a Control Unit

(76) Inventor: Christian John Robert Friberg, Nacka (SE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/912,487

(22) PCT Filed: Apr. 25, 2006
(86) PCT No.: PCT/SE2006/000473

§ 371 Date: Oct. 24, 2007

(30) Foreign Application Priority Data
Apr. 28, 2005 (SE) 0500949-3

(51) Int. Cl. F16L 11/00

(52) U.S. Cl. 138/109

(57) ABSTRACT

A connection device connects a portable pneumatic power tool to a stationary control unit and communicates pressure air as well as electric signals therebetween via a dual media conduit which includes both an air duct and an electric wiring. The connection device includes a connector plug and a jack, wherein the connector plug includes a tubular body with a central air passage and a number of external contact surfaces, and the jack includes a tubular main portion for receiving the connector plug body and having both a socket portion for communicating with the air passage of the connector plug, and a number of leaf spring contact elements for engaging the contact surfaces on the connector plug body.

This invention relates to an improved communication means for communicating both pressure air and electricity between a portable pneumatic power tool and a remotely located control unit.

This has become a necessity since some pneumatic power tools during recent years have been provided with electrically operated sensors for output torque, rotational movement etc., and communication has usually been performed via a pressure air hose and an electric cable. However, there is a problem how to practically and safely route the pressure air hose and the electric cable between the power tool and the control unit such that tool handling is not unnecessarily disturbed. A bad conduit routing may even cause injury risks for the operator.

Until now, the air hose and the electric cable in this type of power tools have been routed separately or clamped together by some kind of clips or tape, thereby attempting to simplify handling of the power tool. The power tools have also been provided with two separate connections for the pressure air hose and the electric cable, which is not satisfactory since the two separate connections make the tool bulky and difficult to use in certain applications. The clamped or taped-together cable and air hose has also been awkward to handle and/or just looked untidy and less professional.

According to the invention, this problem is solved by using a flexible conduit including a pressure air duct and an electric wiring as integral parts of the conduit, and that a novel plug and jack connection means is provided between the conduit and the power tool, which enables a simultaneous connection of pressure air and electrics between the conduit and the power tool in a single connection point.

In particular, the invention concerns an improved connection means for a power tool and a combined pneumatic and electric conduit, wherein the two media are connected simultaneously to the power tool via a dual media plug/jack connection device.

Further characteristic features and advantages of the invention will appear from the following specification and claims.

A preferred embodiment of the invention is below described in detail with references to the accompanying drawing.

In the drawing

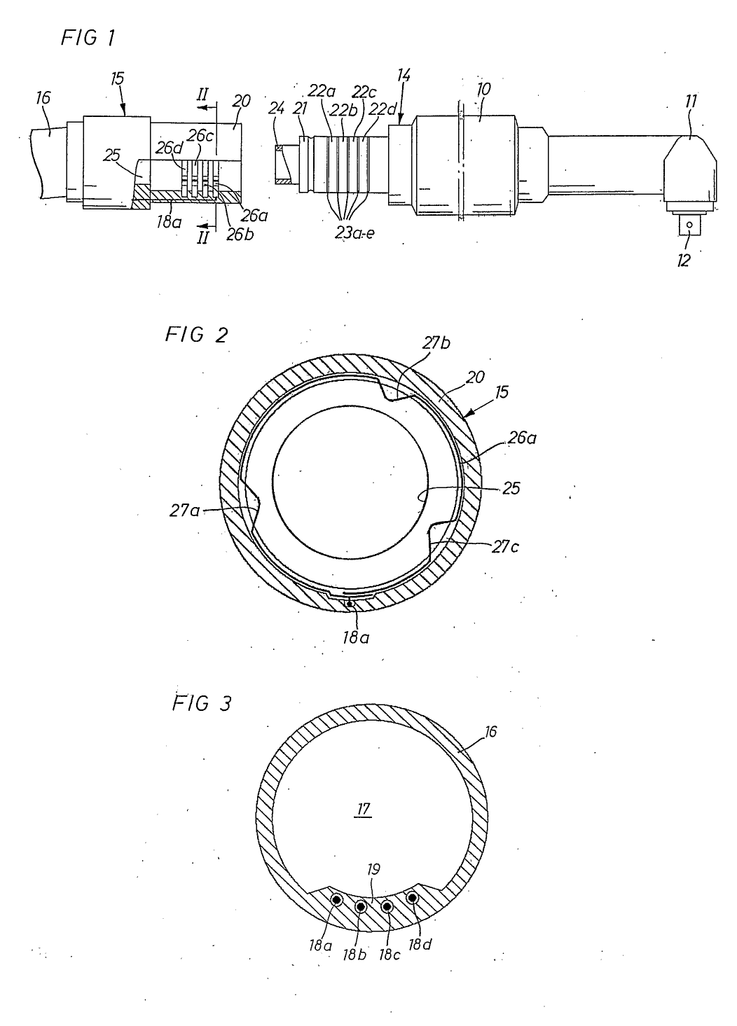

FIG. 1 shows, partly in section, a side view of a power tool with a plug/jack type connection device for a dual media conduit according to the invention.

FIG. 2 shows a cross section of the connection jack shown in FIG. 1.

FIG. 3 shows a cross section of the dual media conduit.

The power tool shown in FIG. 1 is a pneumatic angle nut runner which comprises a housing 10 with an electric motor and a reduction gearing (not shown), an angle head 11 with an output shaft 12. The motor and/or the reduction gearing are provided with one or more sensors for detecting delivered torque, motor temperature etc. and delivering electric signals to a control unit located at a distance from the tool. The tool housing may also be provided with warning lights or other optical information means which are supplied with electric voltage from the control unit. This is common technique and is not described in further detail.

At its rear end the nut runner is provided with a connector plug 14 to be engaged by a jack 15 carried on a dual media conduit 16. As illustrated in FIG. 3, the conduit 16 consists of a flexible hose with a central pressure air duct 17 and a number of electric wires 18 a-d located in a thickened portion 19 of the hose wall. The pressure air duct 17 communicates with a pressure air source, whereas the electric wires 18 a-d are connected to the control unit. The electric wires 18 a-d are connected to on-board sensors like torque transducer, motor temperature sensor, and/or information means like LED indicators for different operational functions.

The connector plug 14 comprises a tubular connector body 21 which is provided with a number of external contact surfaces 22 a-d which are formed by electrically leading material rings which are insulated relative to each other as well as to the connector body 21 by layers 23 a-e of insulating material. The connector body 21 also comprises a central air passage 24 for communicating with a matching socket portion 25 in the jack 15.

The jack 15 comprises a tubular main portion 20 which is arranged to receive the connector plug connector body 21 when making up the connection between the power tool and the conduit 16. The socket portion 25 is concentric with the main portion 20 of the jack 15.

The wires 18 a-d of the conduit 16 extend into the jack 15 and are connected to a number of contact elements in the form of annular leaf spring elements 26 a-d disposed in circumferential grooves in the tubular main portion 20 of the jack 15. As illustrated in FIG. 2, each one of the leaf spring elements 26 a-d is formed with V-shaped contact portions 27 a-c for engagement with one of the contact surfaces 22 a-d on the connector plug 14 as the plug ijack connection is made up. Each spring element 26 a-d is open ended for increased elasticity, and one of the wires 18 a is connected to one of the free ends of the spring element 26 a-d.

At interconnection of the power tool and the conduit 16 the plug 14 and the jack 15 are put together, wherein the air duct 17 of the conduit 16 is put into communication with the air passage 24 via the socket 25 in the jack 15, and the power tool is put in communication with a pressure air source. At the same time, the wires 18 a-d of the conduit 16 are put in communication with the contact surfaces 22 a-d via the contact elements 26 a-d. This means that a single coupling operation puts the power tool into communication with both a pressure air source and with electric control means. It also means that the power tool can be connected to both pneumatic and electric communication means via a single connection point on the tool. This results not only in a faster and easier connection of the power tool to the conduit 16 but also a less bulky power tool compared to state of the art tools with separate connections for pressure air and electricity.

Although not illustrated in the drawing figures, the plug and jack are provided with a lock means for axially interlocking the two parts during operation of the power tool. Lock means for this purpose are well known in this technical field and do not require any specific description.

It is to be noted that the embodiments of the invention are not limited to the described example but can be freely varied within the scope of the claims. For instance, the number of spring elements 26 a-d and contact surfaces 22 a-d may be of any desired number to cope with the actual operation requirements.

1-4. (canceled)

5. A communication system for interconnecting a portable pneumatic power tool and a remotely located control unit, comprising:
a pressure air supply means and an electricity communication means,
wherein the electricity communication means is connected at one end to one or more operational function responsive sensors and signal means on-board the power tool and at the other end to a remotely located operation control unit, and wherein the pressure air supply means and the electricity communication means comprise an air duct and an electric wiring formed as integral parts of a flexible conduit,
and wherein:
an interconnection means between the power tool and said flexible conduit comprises a connector plug and a matching connector jack,
said connector plug comprises a tubular connector body having a central air passage, and one or more external annular contact surfaces communicating with said electric wiring and disposed co-axially relative to each other as well as to the connector body, and
said connector jack comprises a socket portion for communicating with the central air passage of said connector body, and one or more contact elements for individual interconnection with said contact surface or surfaces on said connector body.

6. The communication system according to claim 5, wherein said one or more contact elements of said connector jack comprises one or more leaf spring ring elements spring radially biased into contact with each one of said contact surfaces.

7. The communication means according to claim 6, wherein each one of said ring elements comprises two or more contact portions for engagement with said contact surface or surfaces.
